(19) United States
(12) Patent Application Publication
(10) Pub. No.: US 2012/0035828 A1
(43) Pub. Date: Feb. 9, 2012

(54) DRIVE CONTROL DEVICE FOR A VEHICLE

(75) Inventors: Satoshi Yamanaka, Susono-shi (JP); Yoji Takanami, Anjyou-shi (JP); Tomoyuki Honda, Numazu-shi (JP); Takayuki Amaya, Mishima-shi (JP); Koji Sugiyama, Mishima-shi (JP)

(73) Assignee: TOYOTA JIDOSHA KABUSHIKI KAISHA, Toyota-shi, Aichi (JP)

(21) Appl. No.: 13/259,942

(22) PCT Filed: Apr. 3, 2009
(86) PCT No.: PCT/JP2009/056966

§ 371 Date: Sep. 23, 2011

(51) Int. Cl. F02D 28/00

(52) U.S. Cl. 701/102

(57) ABSTRACT

A drive control device for a vehicle is preferably used for controlling an internal combustion engine and/or a transmission, for example. A total fuel consumption amount calculating unit calculates total fuel consumption amount by integrating fuel consumption when the vehicle travels a unit distance at a predetermined vehicle speed and a predetermined acceleration, with respect to a time axis in accordance with a target distance. A traveling pattern calculating unit calculates a traveling pattern indicating a relationship between a vehicle speed and an acceleration when the vehicle travels the target distance, based on the total fuel consumption amount. By performing the control based on the calculated traveling pattern, it is possible to optimize the total fuel consumption amount. Therefore, it becomes possible to improve the actual fuel consumption.

### TECHNICAL FIELD

The present invention relates to a drive control device for a vehicle.

### BACKGROUND TECHNIQUE

Conventionally, there is proposed various kinds of techniques for improving fuel consumption of a vehicle. For example, in Patent Reference-1, there is proposed a technique for dividing a route to a destination and for calculating a vehicle speed pattern in which fuel consumption amount becomes minimal for each divided route. Additionally, in Patent Reference-2, there is proposed a technique for automatically controlling an accelerator opening degree so that the accelerator opening degree is set to an opening degree for a fuel consumption saving.

Patent Reference-1: Japanese Patent Application Laid-open under No. 2008-32542

Patent Reference-2: Japanese Patent Application Laid-open under No. 2006-336601

### DISCLOSURE OF INVENTION

### Problem To Be Solved By the Invention

However, the technique described in the Patent Reference-1 does not consider that total fuel consumption amount is minimized in consideration of the acceleration. For example, the technique does not consider that, when the vehicle travels a long distance, an acceleration at which the vehicle performs a steady traveling in a short time improves the total fuel consumption amount more effectively than when the vehicle travels a short distance, even if the fuel consumption amount gets worth at the time of the acceleration. Additionally, the technique described in the Patent Reference-2 does not consider that the total fuel consumption amount is minimized in consideration of acceleration, either.

The present invention is made to solve the problem described above, and it is an object of the invention to provide a drive control device for a vehicle capable of calculating an optimum traveling pattern based on total fuel consumption amount when the vehicle travels a target distance.

### Means For Solving the Problem

According to one aspect of the present invention, there is provided a drive control device for a vehicle, including: a total fuel consumption amount calculating unit which calculates total fuel consumption amount by integrating fuel consumption when the vehicle travels a unit distance at a predetermined vehicle speed and a predetermined acceleration, with respect to a time axis in accordance with a target distance; and a traveling pattern calculating unit which calculates a traveling pattern indicating a relationship between a vehicle speed and an acceleration when the vehicle travels the target distance, based on the total fuel consumption amount.

The above drive control device for the vehicle is preferably used for controlling an internal combustion engine and/or a transmission, for example. The total fuel consumption amount calculating unit calculates the total fuel consumption amount by integrating the fuel consumption when the vehicle travels the unit distance at the predetermined vehicle speed and the predetermined acceleration, with respect to the time axis in accordance with the target distance. Then, the traveling pattern calculating unit calculates the traveling pattern indicating the relationship between the vehicle speed and the acceleration when the vehicle travels the target distance, based on the total fuel consumption amount. By performing the control based on the calculated traveling pattern, it is possible to optimize the total fuel consumption amount. Therefore, it becomes possible to improve the actual fuel consumption.

In a manner of the above drive control device for the vehicle, the traveling pattern calculating unit calculates the traveling pattern so that the total fuel consumption amount becomes minimal.

According to the manner, by performing the control based on the calculated traveling pattern, it becomes possible to minimize the total fuel consumption amount when the vehicle travels the target distance.

In another manner of the above drive control device for the vehicle, the traveling pattern calculating unit obtains a limit value of fuel consumption amount from outside, and calculates the traveling pattern so that the total fuel consumption amount becomes equal to or smaller than the limit value.

According to the manner, it becomes possible to appropriately perform the optimum traveling within the total fuel consumption amount corresponding to the obtained limit value.

In another manner of the above drive control device for the vehicle, the traveling pattern calculating unit obtains a vehicle speed when the vehicle performs a steady traveling, from outside, and calculates the traveling pattern so that the vehicle performs the steady traveling at the vehicle speed.

According to the manner, it becomes possible to appropriately satisfy the constraint condition related to the obtained steady traveling speed and optimize the total fuel consumption amount.

In another manner of the above drive control device for the vehicle, the traveling pattern calculating unit obtains target arrival time to arrive at the target distance, from outside, and calculates the traveling pattern so that arrival time to arrive at the target distance becomes equal to or shorter than the target arrival time.

According to the manner, it becomes possible to appropriately satisfy the constraint condition related to the obtained target arrival time and optimize the total fuel consumption amount.

In another manner of the above drive control device for the vehicle, the traveling pattern calculating unit obtains a maximum acceleration from outside, and calculates the traveling pattern so that a maximum value of an acceleration generated by the time the vehicle arrives at the target distance becomes the maximum acceleration.

According to the manner, it becomes possible to appropriately satisfy the constraint condition related to the obtained maximum acceleration and optimize the total fuel consumption amount.

According to another aspect of the present invention, there is provided a drive control device for a vehicle, including: a unit which calculates a traveling pattern indicating a relationship between a vehicle speed and an acceleration when the vehicle travels a target distance so that, when the target distance is equal to or larger than a predetermined distance, a steady traveling is performed in a shorter time than when the target distance is smaller than the predetermined distance.

According to the above drive control device for the vehicle, by performing the control based on the calculated traveling pattern, it is possible to optimize the total fuel consumption amount, too. Therefore, it becomes possible to improve the actual fuel consumption.

### BRIEF DESCRIPTION OF THE DRAWINGS

FIG. 1 is a schematic diagram showing a system example to which a drive control device for a vehicle in the invention is applied.

FIG. 2 is a block diagram schematically showing a configuration of an ECU.

FIGS. 3A and 3B are diagrams for explaining a calculating manner of fuel consumption needed to travel a unit distance.

FIG. 4 is a diagram for explaining a relationship between a vehicle speed and an acceleration in case of using the same fuel consumption.

FIGS. 5A and 5B are diagrams for explaining a difference of fuel consumption depending on a traveling pattern.

FIGS. 6A and 6B are diagrams for explaining a calculating method of a traveling pattern in a first embodiment.

FIG. 7 shows an example of a map of traveling patterns stored in an ECU.

FIGS. 8A and 8B are diagrams for explaining a calculating method of a traveling pattern in a second embodiment.

FIGS. 9A and 9B are diagrams for explaining a calculating method of a traveling pattern in a third embodiment.

FIGS. 10A and 10B are diagrams for explaining a calculating method of a traveling pattern in a first example of a fourth embodiment.

FIGS. 11A and 11B are diagrams for explaining a calculating method of a traveling pattern in a second example of a fourth embodiment.

FIGS. 12A and 12B are diagrams for explaining a calculating method of a traveling pattern in a fifth embodiment.

FIG. 13 is a flow chart showing a control process in a sixth embodiment.

### DETAILED DESCRIPTION OF THE PREFERRED EMBODIMENTS

Preferred embodiments of the present invention will be explained hereinafter with reference to the drawings.

### Device Configuration

FIG. 1 is a schematic diagram showing a system example to which the drive control device for the vehicle in the invention is applied. The system is mounted on the vehicle, and mainly includes a fuel-efficient traveling mode switch 1, a constraint condition input unit 2, a navigation system 3, a vehicle speed sensor 4, an acceleration sensor 5, an accelerator opening degree sensor 6, an engine (internal combustion engine) 8, a continuously variable transmission 9 and an ECU (Electronic Control Unit) 10.

The fuel-efficient traveling mode switch 1 is operated by the driver in order to set a mode (hereinafter referred to as “fuel-efficient traveling mode”) for making the vehicle perform the fuel-efficient traveling. The fuel-efficient traveling mode corresponds to the mode for making the vehicle travel so that the fuel consumption is optimized under the condition obtained by the constraint condition input unit 2. The signal corresponding to the on-state or the off-state of the fuel-efficient traveling mode switch 1 is provided to the ECU 10.

The constraint condition input unit 2 is formed so that the driver can input a condition (hereinafter referred to as “constraint condition”) which the vehicle needs to satisfy when the fuel-efficient traveling mode is set. For example, the constraint condition input unit 2 is formed by keys, switches, buttons, a remote controller and a touch panel provided on a display screen of a display. The constraint condition corresponds to a distance which the vehicle travels in the fuel-efficient traveling mode, a speed when the vehicle performs a steady traveling and a maximum acceleration, which will be described in details, later. The signal corresponding to the constraint condition input by the constraint condition input unit 2 is provided to the ECU 10.

The navigation system 3 displays a current position of the vehicle on the display screen and shows a route to a destination, by using a GPS (Global Positioning System). In addition, the navigation system 3 obtains various kinds of information (for example, information including a speed limit and a traffic flow) from a server via a communication device (which is not shown). The signal corresponding to the information obtained by the navigation system 3 is provided to the ECU 10.

The vehicle speed sensor 4 is formed to be able to detect the vehicle speed, and the acceleration sensor 5 is formed to be able to detect the acceleration, and the accelerator opening degree sensor 6 is formed to be able to detect the accelerator opening degree corresponding to the operation of the accelerator pedal by the driver. The vehicle speed sensor 4, the acceleration sensor 5 and the accelerator opening degree sensor 6 provide the ECU 10 with the detecting signals corresponding to the detected vehicle speed, the detected acceleration and the detected accelerator opening degree, respectively.

The engine 8 generates the driving force of the vehicle by burning the fuel-air mixture of the air and the fuel. The engine 8 is controlled by the control signal provided by the ECU 10. The continuously variable transmission 9 is the power transmission mechanism which is formed to continuously vary the gear ratio and transmit the power generated by the engine 8. The continuously variable transmission 9 is controlled by the control signal provided by the ECU 10.

The ECU 10 includes a CPU (Central Processing Unit), a ROM (Read Only Memory) and a RAM (Random Access Memory), which are not shown, and performs various kinds of controls of each component in the vehicle. For example, the ECU 10 controls the engine 8 and the continuously variable transmission 9 based on the above provided signals.

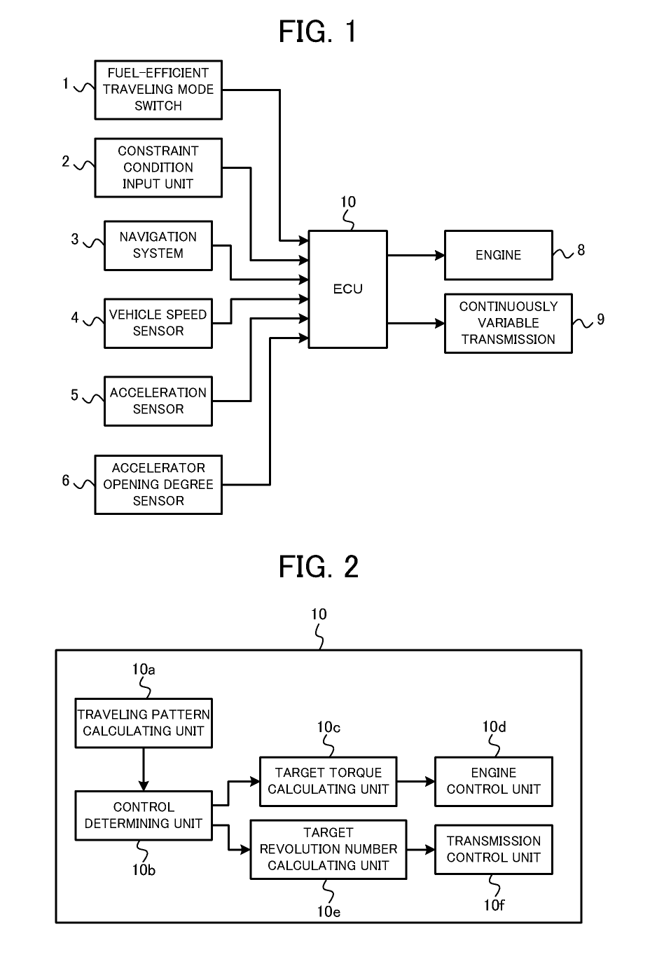

FIG. 2 is a block diagram schematically showing a configuration of the ECU 10. As shown in FIG. 2, the ECU 10 includes a traveling pattern calculating unit 10a, a control determining unit 10b, a target torque calculating unit 10c, an engine control unit 10d, a target revolution number calculating unit 10e and a transmission control unit 10f.

In the embodiment, when the fuel-efficient traveling mode is selected by the driver, the ECU 10 calculates a traveling pattern so that the constraint condition input by the driver is satisfied and total fuel consumption amount is optimized. Here, “traveling pattern” corresponds to a pattern indicating a relationship between the vehicle speed and the acceleration (target acceleration) when the vehicle travels a target distance (corresponding to a distance to a destination input by the driver via the constraint condition input unit 2. The same will apply hereinafter.). In other words, “traveling pattern” corresponds to a manner of varying the acceleration (target acceleration) in order to vary the vehicle speed when the vehicle travels the target distance.

Then, the ECU 10 controls the engine 8 and the continuously variable transmission 9, based on the calculated traveling pattern. Concretely, the ECU 10 controls the driving force (engine torque) of the engine 8 and the gear ratio of the continuously variable transmission 9 so that the traveling corresponding to the traveling pattern is realized (in details, the vehicle speed and the acceleration corresponding to the traveling pattern are realized), based on the target distance and the current vehicle speed. Thus, the ECU 10 corresponds to the drive control device for the vehicle in the invention, and functions as the total fuel consumption amount calculating unit and the traveling pattern calculating unit.

A concrete description will be given of a process and a control performed by the ECU 10. The traveling pattern calculating unit 10a calculates the traveling pattern based on the signals provided by the fuel-efficient traveling mode switch 1, the constraint condition input unit 2 and the navigation system 3. The method for calculating the traveling pattern will be described in details, later. The control determining unit 10b determines whether or not the control on the basis of the traveling pattern calculated by the traveling pattern calculating unit 10a should be performed, based on the signal provided by the accelerator opening degree sensor 6. In details, when the driver operates the accelerator pedal (namely, the accelerator pedal becomes the on-state), the control determining unit 10b determines that the control on the basis of the traveling pattern should be performed. This is because, only when the driver indicates the intention to start the traveling of the vehicle, the control on the basis of the traveling pattern should be performed.

The target torque calculating unit 10c calculates the target torque based on the traveling pattern, and the engine control unit 10d controls the engine 8 based on the target torque calculated by the target torque calculating unit 10c. The target revolution number calculating unit 10e calculates the target number of revolutions of the continuously variable transmission 9 based on the traveling pattern, and the transmission control unit 10f controls the continuously variable transmission 9 based on the target number of revolutions calculated by the target revolution number calculating unit 10e.

### Calculating Method of Traveling Pattern

Next, a concrete description will be given of the calculating method of the traveling pattern in the embodiment. In the embodiment, the total fuel consumption amount (hereinafter suitably referred to as “fuel consumption amount”) is calculated by integrating the fuel consumption when the vehicle travels the unit distance at the predetermined vehicle speed and the predetermined acceleration, with respect to the time axis in accordance with the target distance. Then, the traveling pattern is calculated by the total fuel consumption amount. For example, the traveling pattern is calculated so that the total fuel consumption amount becomes minimal.

The reason will be described below. Generally, as for the vehicle including the continuously variable transmission, the speed change control of the continuously variable transmission is performed so that the engine operates in accordance with the fuel consumption optimum line. The control in accordance with the fuel consumption optimum line corresponds to the control of the engine at the most efficient operation point for making the engine perform arbitrary amount of work. Therefore, even if the control in accordance with the fuel consumption optimum line is performed, it is thought that the fuel consumption amount is varied by the manner of the acceleration and the vehicle speed at the time of the steady traveling. For example, when the acceleration is high, the vehicle arrives at the destination in a short time, but there is a possibility that the vehicle uses extra fuel depending on the traveling distance.

Therefore, in the embodiment, the traveling pattern is calculated in consideration of the above total fuel consumption amount, and the control of the engine 8 and the continuously variable transmission 9 is performed based on the traveling pattern.

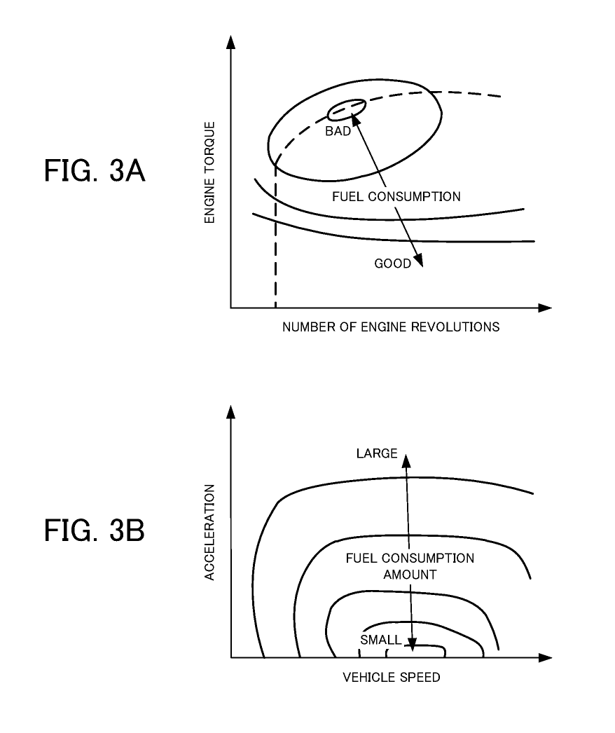

Next, a description will be given of a basic concept of the calculating method of the traveling pattern in the embodiment, with reference to FIGS. 3A and 3B to FIGS. 5A and 5B.

FIGS. 3A and 3B are diagrams for explaining a calculating manner of the fuel consumption needed to travel the unit distance. In FIG. 3A, a horizontal axis shows a number of engine revolutions, and a vertical axis shows an engine torque. Concretely, in FIG. 3A, a solid line shows an example of an equal fuel consumption line of the engine 8, and a broken line shows an example of a fuel consumption optimum line of the engine 8. In FIG. 3B, a horizontal axis shows a vehicle speed, and a vertical axis shows an acceleration. Concretely, in FIG. 3B, fuel consumption needed to travel the unit distance are shown by contour lines. For example, fuel consumption (g/m) needed to travel “1 (m)” is shown. According to FIG. 3B, the fuel consumption when the vehicle travels the unit distance at the predetermined vehicle speed and the predetermined acceleration is obtained.

On the assumption that the engine 8 operates in accordance with the fuel consumption optimum line, the fuel consumption needed to travel the unit distance as shown in FIG. 3B is calculated by performing an experiment and/or a simulation for each vehicle. For example, the fuel consumption is calculated in consideration of a travel resistance for each vehicle, too. In the embodiment, based on the above fuel consumption needed to travel the unit distance, the total fuel consumption amount is calculated by integrating the fuel consumption when the vehicle travels the unit distance at the predetermined vehicle speed and the predetermined acceleration, with respect to the time axis in accordance with the target distance.

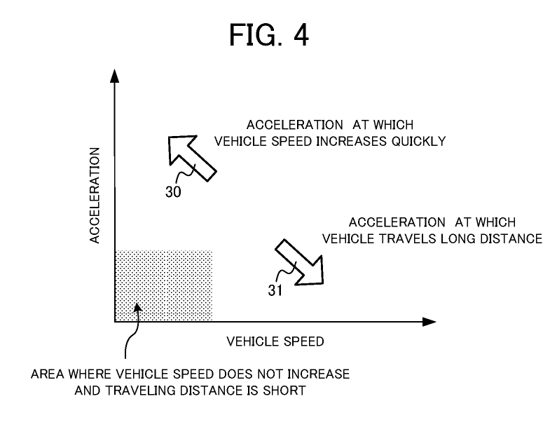

FIG. 4 is a diagram for explaining a relationship between the vehicle speed and the acceleration in case of using the same fuel consumption. In FIG. 4, a horizontal axis shows a vehicle speed, and a vertical axis shows an acceleration. When the acceleration is varied by the same fuel consumption so as to vary the vehicle speed, the acceleration shown by an arrow 30 corresponds to the acceleration at which the vehicle speed increases quickly, and the acceleration shown by an arrow 31 corresponds to the acceleration at which the vehicle travels the long distance. Additionally, the acceleration shown by a hatching area corresponds to the acceleration at which the vehicle speed does not increase and the traveling distance is short. As shown in FIG. 4, if the vehicle speed increases quickly and then the acceleration decreases so as to shift to the steady traveling (in other words, constant speed running), it is thought that the total fuel consumption amount tends to become relatively small.

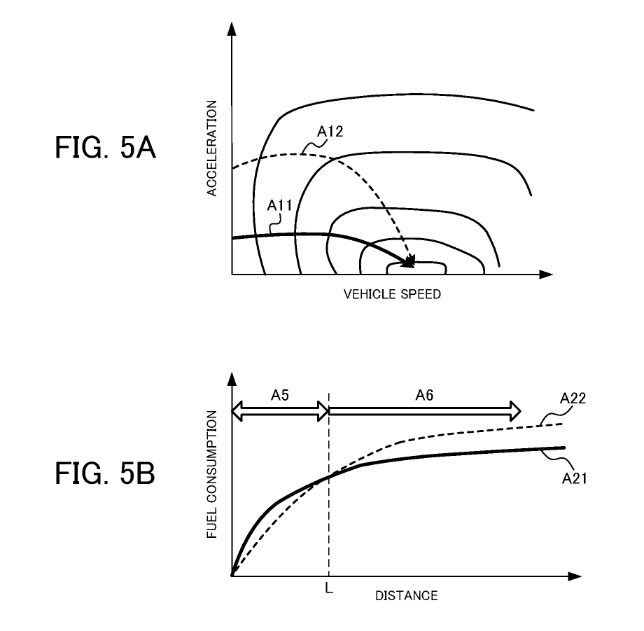

FIGS. 5A and 5B are diagrams for explaining a difference of the fuel consumption depending on the traveling pattern. In FIG. 5A, a horizontal axis shows a vehicle speed, and a vertical axis shows an acceleration, and contour lines show the fuel consumption needed to travel the unit distance. The contour lines of the fuel consumption shown in FIG. 5A are the same as the contour lines shown in FIG. 3B.

Here, a description will be given of an example in such a case that the vehicle travels in the traveling patterns shown by arrows A11 and A12. The traveling pattern A11 corresponds to the traveling pattern in which the vehicle shifts to the steady traveling without increasing the acceleration, and the traveling pattern A12 corresponds to the traveling pattern in which the vehicle speed increases quickly and then the acceleration decreases so as to shift to the steady traveling. In both the traveling patterns A11 and A12, it is assumed that the steady traveling is performed by the optimum vehicle speed at which the fuel consumption becomes minimal.

In FIG. 5B, a horizontal axis shows a distance, and a vertical axis shows a fuel consumption. Concretely, a solid line A21 shows a relationship between the distance and the fuel consumption when the vehicle travels in the traveling pattern A11, and a broken line A22 shows a relationship between the distance and the fuel consumption when the vehicle travels in the traveling pattern A12. As shown in

FIG. 5B, when the vehicle travels the distance below the distance L (see an arrow A5), it can be understood that, when the vehicle travels in the traveling pattern A11, the fuel consumption is better than when the vehicle travels in the traveling pattern A12. In contrast, when the vehicle travels the distance exceeding the distance L (see an arrow A6), it can be understood that, when the vehicle travels in the traveling pattern A12, the fuel consumption is better than when the vehicle travels in the traveling pattern A11. This is because, when the vehicle travels in the traveling pattern A12, the vehicle can shift to the steady traveling in a shorter time than when the vehicle travels in the traveling pattern A11.

Thus, in the embodiment, the traveling pattern is calculated so that, when the target distance is equal to or larger than the predetermined distance, the steady traveling is performed in a shorter time than when the target distance is smaller than the predetermined distance. In other words, the traveling pattern is calculated so that the vehicle speed increased quickly by increasing the acceleration and then the vehicle shifts to the steady traveling. The predetermined distance can be obtained by performing an experiment or a simulation for each vehicle.

By performing the drive control based on the calculated traveling pattern, it becomes possible to improve the actual fuel consumption. Concretely, it becomes possible to minimize the total fuel consumption amount.

Hereinafter, a description will be given of embodiments (first to sixth embodiments) of the calculating method of the traveling pattern.

### First Embodiment

In a first embodiment, the traveling pattern is calculated so that the total fuel consumption amount becomes minimal. Concretely, when the driver selects the fuel-efficient traveling mode and inputs the distance (target distance) as the constraint condition, the ECU 10 calculates the traveling pattern in which the total fuel consumption amount becomes minimal when the vehicle travels the target distance. Namely, under the constraint condition of the target distance, the ECU 10 calculates the optimum traveling pattern to the destination, based on the relationship between the vehicle speed and the acceleration in which the fuel consumption needed to travel the unit distance becomes minimal when the engine 8 operates in accordance with the fuel consumption optimum line.

By performing the drive control based on the calculated traveling pattern, it becomes possible to minimize the total fuel consumption amount when the vehicle travels the target distance.

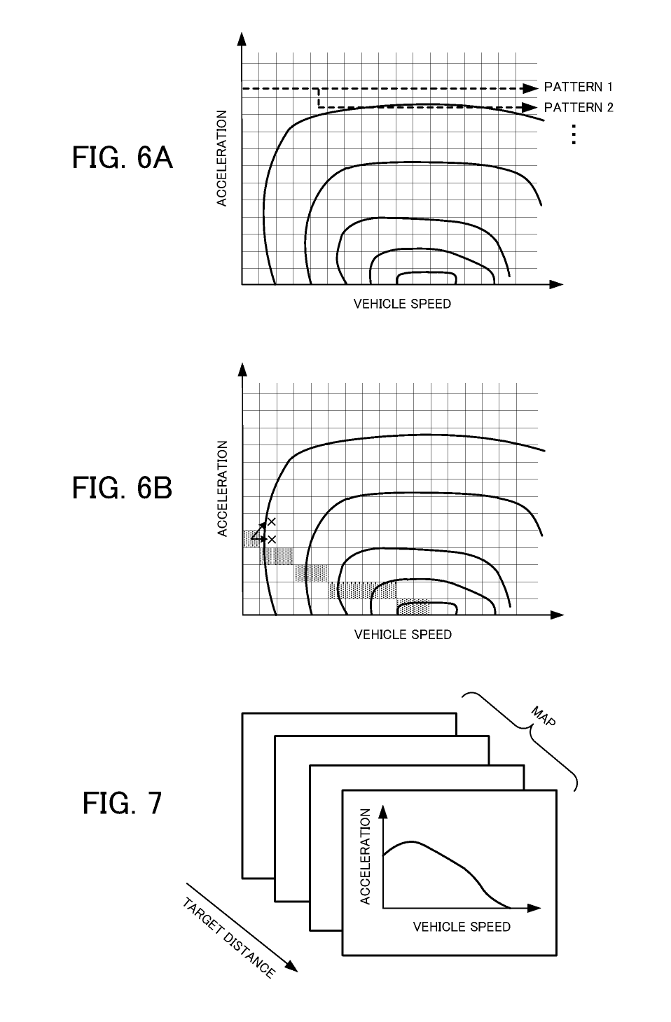

FIGS. 6A and 6B are diagrams for explaining the calculating method of the traveling pattern in the first embodiment. In FIGS. 6A and 6B, a horizontal axis shows a vehicle speed, and a vertical axis shows an acceleration, and contour lines show the fuel consumption needed to travel the unit distance, respectively. The contour lines of the fuel consumption shown in FIGS. 6A and 6B are the same as the contour lines shown in FIG. 3B.

FIG. 6A shows examples of the traveling patterns (patterns 1 and 2) at the time of the calculation. In the first embodiment, as for all of the assumed traveling patterns when the vehicle travels the target distance, the fuel consumption when the vehicle travels the unit distance at the predetermined vehicle speed and the predetermined acceleration is integrated with respect to the time axis so as to calculate the total fuel consumption amount. Concretely, as shown by a grid in FIG. 6A, in consideration of a matrix defined by the vehicle speed and the acceleration, the total fuel consumption amount for all of the assumed traveling patterns is calculated. Then, the traveling pattern corresponding to the smallest total fuel consumption amount in the calculated total fuel consumption amount is adopted as the optimum traveling pattern. This corresponds to the search of the route related to the acceleration with respect to the vehicle speed, in which the value of integral of the fuel consumption becomes minimal.

FIG. 6B shows an example of a calculation result of the optimum traveling pattern. Concretely, blocks shown by a hatching show the traveling pattern example in which the total fuel consumption amount when the vehicle travels the target distance becomes minimal. “X” in FIG. 6B represents that the optimum fuel consumption is not realized when the acceleration is varied in accordance with “X”.

While the above embodiment shows the example of calculating the total fuel consumption amount for all of the assumed traveling patterns when the vehicle travels the target distance, it is not necessary to calculate the total fuel consumption amount for all of the assumed traveling patterns. For example, as for only the traveling pattern in which it is assumed that the total fuel consumption amount becomes small, the total fuel consumption amount may be calculated. Therefore, it is possible to efficiently calculate the traveling pattern in which the total fuel consumption amount becomes minimal.

Next, a description will be given of concrete examples of the control method performed by the ECU 10 in the first embodiment.

As one example, the optimum traveling patterns (the traveling patterns in which the total fuel consumption amount becomes minimal) for each target distance are preliminarily calculated, and the calculated traveling patterns are stored as a map in the ECU 10.

Then, when the driver selects the fuel-efficient traveling mode and inputs the distance (target distance) as the constraint condition, the ECU 10 reads out the map corresponding to the target distance and controls the engine 8 and the continuously variable transmission 9 in accordance with the map.

FIG. 7 shows an example of the map of the traveling patterns for each target distance, which is stored in the ECU 10. It is not limited that the ECU 10 calculates the map of the traveling patterns. Other computers may preliminarily calculate the map in a design stage of the vehicle, and the map may be stored in the ECU 10.

As another example, instead of using the above map, the ECU 10 calculates the optimum traveling pattern online at the time of each traveling in the fuel-efficient traveling mode. For example, the ECU calculates the optimum traveling pattern, every time a predetermined time elapses, or when the vehicle encounters an impediment (for example, the vehicle stops for a red light or reduces the speed for turning to right or left), or when the driver steps on a brake pedal. Therefore, it becomes possible to calculate the traveling pattern suitable for the situation.

A concrete description will be given of the calculating method of the traveling pattern according to the example. A function f expressed by an equation (1) corresponds to the function in which the fuel consumption needed to travel the unit distance as shown in FIG. 3B is approximated by using the vehicle speed and the acceleration. In the equation (1), “V” indicates the vehicle speed, and “G” indicates the acceleration, and “Q” indicates the fuel consumption. The function f is preliminarily prepared and is stored in the ECU 10.

Q=ƒ(V,G) (1)

When the driver selects the fuel-efficient traveling mode and inputs the target distance as the constraint condition, the ECU 10 calculates the traveling pattern in which the total fuel consumption amount becomes minimal by using an equation (2).

J=∫g(Q)ds (2)

In the equation (2), “J” indicates the total fuel consumption amount needed to travel the target distance, and “g” indicates an evaluation function for an optimization. According to the equation (2), the total fuel consumption amount J is calculated by integrating “Q” shown in the equation (1) with respect to the target distance.

The ECU 10 calculates the total fuel consumption amount J for various kinds of patterns of (V,G) by using the equation (2), and adopts the pattern of (V,G) in which the total fuel consumption amount J becomes minimal, as the optimum traveling pattern. Then, the ECU 10 controls the engine 8 and the continuously variable transmission 9 based on the adopted traveling pattern.

According to the first embodiment, it becomes possible to minimize the total fuel consumption amount when the vehicle travels the target distance.

### Second Embodiment

Next, a description will be given of a second embodiment. The second embodiment is different from the first embodiment in that the traveling pattern is calculated by using a speed (hereinafter referred to as “steady traveling speed”) at the time of the steady traveling in addition to the target distance, as the constraint condition. Concretely, in the second embodiment, when the driver selects the fuel-efficient traveling mode and inputs the target distance and the steady traveling speed as the constraint condition, the ECU 10 calculates the traveling pattern in which such a condition that the vehicle performed the steady traveling at the steady traveling speed when the vehicle travels the target distance is satisfied and the total fuel consumption amount becomes minimal. Namely, under the constraint condition related to the target distance and the steady traveling speed, the ECU 10 calculates the optimum traveling pattern to the destination, based on the relationship between the vehicle speed and the acceleration in which the fuel consumption needed to travel the unit distance becomes minimal when the engine 8 operates in accordance with the fuel consumption optimum line.

The reason will be described below. Since the method shown in the first embodiment only uses the target distance as the constraint condition, the steady traveling speed in the calculated traveling pattern is basically a single value specific to the vehicle. Concretely, the vehicle speed at which the fuel consumption becomes minimal (see FIG. 3B) tends to be set to the steady traveling speed. However, since there is actually the traffic flow, it is thought that there is a case that the steady traveling speed is unsuitable for the traffic flow.

Therefore, in the second embodiment, the traveling pattern is calculated in consideration of the steady traveling speed specified by the driver, too. Concretely, the ECU 10 calculates the traveling pattern in which the vehicle speed finally reaches the specified steady traveling speed and the total fuel consumption amount becomes minimal when the vehicle travels the target distance. Namely, in the traveling patterns in which the speed that the vehicle finally reaches at the time of traveling the target distance becomes the steady traveling speed, the ECU 10 selects the traveling pattern in which the total fuel consumption amount becomes minimal.

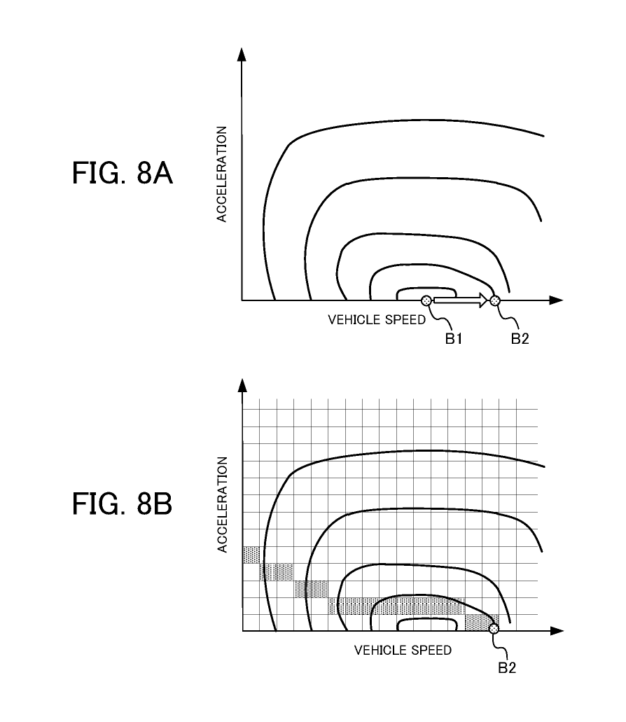

FIGS. 8A and 8B are diagrams for explaining the calculating method of the traveling pattern in the second embodiment. In FIGS. 8A and 8B, a horizontal axis shows a vehicle speed, and a vertical axis shows an acceleration, and contour lines show the fuel consumption needed to travel the unit distance, respectively. The contour lines of the fuel consumption shown in FIGS. 8A and 8B are the same as the contour lines shown in FIG. 3B.

FIG. 8A shows an example of a target operation point when the driver specifies the steady traveling speed. A vehicle speed shown by a point B1 corresponds to the vehicle speed at which the fuel consumption becomes minimal. When the steady traveling speed is not used as the constraint condition, the traveling pattern in which the steady traveling is performed at the vehicle speed B1 is basically calculated. Here, a description will be given of an example in such a case that the driver specifies the vehicle speed shown by a point B2 as the steady traveling speed. The steady traveling speed B2 is larger than the vehicle speed B1 at which the fuel consumption becomes minimal (see a white arrow).

FIG. 8B shows an example of a calculation result of the optimum traveling pattern. In the second embodiment, the ECU 10 calculates the traveling pattern in which the vehicle speed finally reaches the steady traveling speed B2 and the total fuel consumption amount becomes minimal when the vehicle travels the target distance. Basically, the ECU 10 calculates the traveling pattern by the method shown in the first embodiment. As a result, the traveling pattern shown by a hatching block in FIG. 8B is calculated, for example. The ECU 10 controls the engine 8 and the continuously variable transmission 9 based on the calculated traveling pattern.

According to the second embodiment, it becomes possible to appropriately satisfy the constraint condition related to the steady traveling speed specified by the driver and minimize the total fuel consumption amount.

### Third Embodiment

Next, a description will be given of a third embodiment. The third embodiment is different from the first and second embodiments in that the traveling pattern is calculated by using a target arrival time to arrive at the target distance in addition to the target distance, as the constraint condition. Concretely, in the third embodiment, when the driver selects the fuel-efficient traveling mode and inputs the target distance and the target arrival time as the constraint condition, the ECU 10 calculates the traveling pattern in which arrival time to arrive at the target distance becomes equal to or shorter than the target arrival time and the total fuel consumption amount becomes minimal. Namely, under the constraint condition related to the target distance and the target arrival time, the ECU 10 calculates the optimum traveling pattern to the destination, based on the relationship between the vehicle speed and the acceleration in which the fuel consumption needed to travel the unit distance becomes minimal when the engine 8 operates in accordance with the fuel consumption optimum line.

This is because, since the target distance is only used as the constraint condition in the method according to the first embodiment, when the vehicle travels in the calculated traveling pattern, it tends to take a long time to arrive at the destination due to an insufficiency of the vehicle speed and the acceleration.

Therefore, in the third embodiment, the traveling pattern is also calculated in consideration of the target arrival time to arrive at the target distance, which is specified by the driver. Concretely, the ECU 10 calculates the traveling pattern in which the arrival time to arrive at the target distance becomes equal to or shorter than the target arrival time and the total fuel consumption amount becomes minimal. Namely, in the traveling patterns in which the arrival time to arrive at the target distance becomes equal to or shorter than the target arrival time, the ECU 10 selects the traveling pattern in which the total fuel consumption amount becomes minimal.

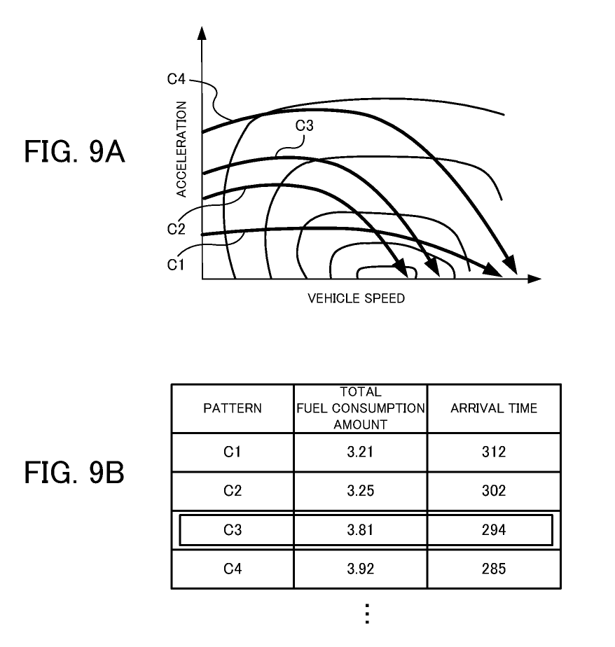

FIGS. 9A and 9B are diagrams for explaining the calculating method of the traveling pattern in the third embodiment. In FIG. 9A, a horizontal axis shows a vehicle speed, and a vertical axis shows an acceleration, and contour lines show the fuel consumption needed to travel the unit distance. The contour lines of the fuel consumption shown in FIG. 9A are the same as the contour lines shown in FIG. 3B.

Concretely, examples of the traveling patterns (traveling patterns C1 to C4) at the time of the calculation are shown by arrows in FIG. 9A. The traveling patterns C1 to C4 correspond to the examples of the traveling patterns calculated by the method shown in the first embodiment, by using the target distance as the constraint condition.

FIG. 9B shows the total fuel consumption amount and the arrival time which are calculated for the traveling patterns C1 to C4. Here, it is assumed that “300” is specified as the target arrival time. As for the traveling patterns C1 to C4 shown in FIG. 9B, it can be understood that the traveling pattern C3 is the pattern in which the arrival time is equal to or shorter than the target arrival time and the total fuel consumption amount becomes minimal. So, the ECU 10 adopts the traveling pattern C3. Then, the ECU 10 controls the engine 8 and the continuously variable transmission 9 based on the adopted traveling pattern C3.

According to the third embodiment, it becomes possible to appropriately satisfy the constraint condition related to the target arrival time specified by the driver and minimize the total fuel consumption amount.

The third embodiment may be performed in combination with the second embodiment. Concretely, the traveling pattern in which the fuel consumption amount becomes minimal may be calculated by using the steady traveling speed in addition to the target distance and the target arrival time, as the constraint condition.

### Fourth Embodiment

Next, a description will be given of a fourth embodiment. The fourth embodiment is different from the first to third embodiments in that the traveling pattern is calculated by using a limit value of the total fuel consumption amount in addition to the target distance, as the constraint condition. Concretely, in the fourth embodiment, the ECU 10 accepts the consumption of fuel of less than or equal to the limit value so as to calculate the traveling pattern.

In details, when the driver selects the fuel-efficient traveling mode and inputs the target distance and the limit value of the total fuel consumption amount as the constraint condition, the ECU calculates the traveling pattern in which the total fuel consumption amount to arrive at the target distance is equal to or less than the limit value and the vehicle speed becomes maximal. Namely, under the constraint condition related to the target distance and the limit value of the total fuel consumption amount, the ECU 10 calculates the optimum traveling pattern to the destination, based on the relationship between the vehicle speed and the acceleration in which the fuel consumption needed to travel the unit distance becomes minimal when the engine 8 operates in accordance with the fuel consumption optimum line.

This is because, since the method shown in the first embodiment only uses the target distance as the constraint condition, when the vehicle travels in the traveling pattern calculated by the method, the vehicle speed tends to be insufficient because the total fuel consumption amount is small.

Therefore, in the fourth embodiment, the ECU 10 calculates the traveling pattern in which the total fuel consumption amount to arrive at the target distance is equal to or less than the limit value and the vehicle speed becomes maximal. As one example (hereinafter referred to as “first example of fourth embodiment”), the ECU 10 calculates the traveling pattern in which the total fuel consumption amount to arrive at the target distance is equal to or less than the limit value and the acceleration becomes maximal. Namely, in the traveling patterns in which the total fuel consumption amount is equal to or less than the limit value, the ECU 10 selects the traveling pattern in which the acceleration becomes maximal.

As another example (hereinafter referred to as “second example of fourth embodiment”), the ECU 10 calculates the traveling pattern in which the total fuel consumption amount to arrive at the target distance is equal to or less than the limit value and the arrival time to arrive at the target distance becomes minimal. Namely, in the traveling patterns in which the total fuel consumption amount is equal to or less than the limit value, the ECU 10 selects the traveling pattern in which the arrival time to arrive at the target distance becomes minimal.

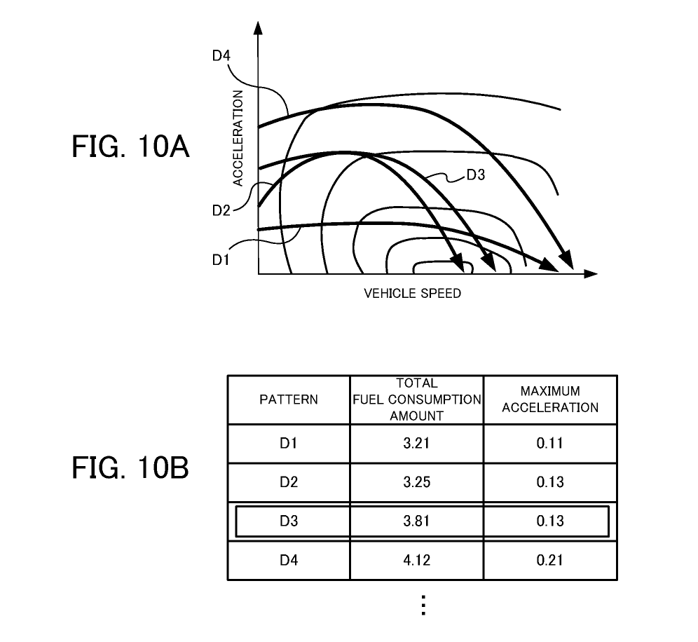

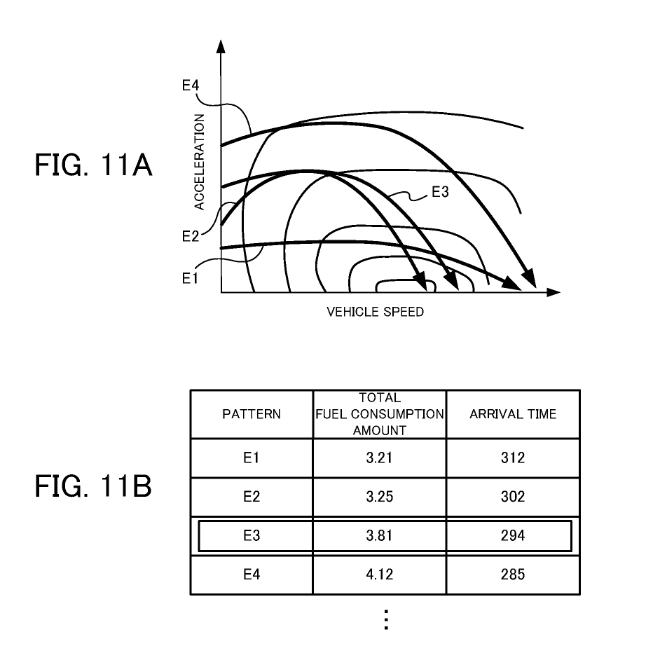

Here, a concrete description will be given of the first example and the second example of the fourth embodiment, with reference to FIGS. 10A and 10B to FIGS. 11A and 11B.

FIGS. 10A and 10B are diagrams for explaining the calculating method of the traveling pattern in the first example of the fourth embodiment. In FIG. 10A, a horizontal axis shows a vehicle speed, and a vertical axis shows an acceleration, and contour lines show the fuel consumption needed to travel the unit distance. The contour lines of the fuel consumption shown in FIG. 10A are the same as the contour lines shown in FIG. 3B.

Concretely, examples of the traveling patterns (traveling patterns D1 to D4) at the time of the calculation are shown by arrows in FIG. 10A. The traveling patterns D1 to D4 correspond to the examples of the traveling patterns calculated by the method shown in the first embodiment, by using the target distance as the constraint condition.

FIG. 10B shows the total fuel consumption amount and the maximum acceleration which are calculated for the traveling patterns D1 to D4. Here, it is assumed that “4” is specified as the limit value of the total fuel consumption amount. As for the traveling patterns D1 to D4 shown in FIG. 10B, it can be understood that the traveling pattern D3 is the pattern in which the total fuel consumption amount is equal to or less than the limit value and the acceleration becomes maximal. So, the ECU 10 adopts the traveling pattern D3. Then, the ECU 10 controls the engine 8 and the continuously variable transmission 9 based on the adopted traveling pattern D3.

FIGS. 11A and 11B are diagrams for explaining the calculating method of the traveling pattern in the second example of the fourth embodiment. In FIG. 11A, a horizontal axis shows a vehicle speed, and a vertical axis shows an acceleration, and contour lines show the fuel consumption needed to travel the unit distance. The contour lines of the fuel consumption shown in FIG. 11A are the same as the contour lines shown in FIG. 3B.

Concretely, examples of the traveling patterns (traveling patterns E1 to E4) at the time of the calculation are shown by arrows in FIG. 11A. The traveling patterns E1 to E4 correspond to the examples of the traveling patterns calculated by the method shown in the first embodiment, by using the target distance as the constraint condition.

FIG. 11B shows the total fuel consumption amount and the arrival time which are calculated for the traveling patterns E1 to E4.

Here, it is assumed that “4” is specified as the limit value of the total fuel consumption amount. As for the traveling patterns E1 to E4 shown in FIG. 11B, it can be understood that the traveling pattern E3 is the pattern in which the total fuel consumption amount is equal to or less than the limit value and the arrival time becomes minimal.

So, the ECU 10 adopts the traveling pattern E3. Then, the ECU 10 controls the engine 8 and the continuously variable transmission 9 based on the adopted traveling pattern E3.

According to the fourth embodiment, it becomes possible to appropriately perform the optimum traveling within the limit value of the total fuel consumption amount specified by the driver.

The fourth embodiment may be performed in combination with the second embodiment and/or the third embodiment. Concretely, the traveling pattern may be calculated by using the steady traveling speed and/or the target arrival time in addition to the target distance and the limit value of the total fuel consumption amount, as the constraint condition.

### Fifth Embodiment

Next, a description will be given of a firth embodiment. The fifth embodiment is different from the first to fourth embodiments in that the traveling pattern is calculated by using a maximum acceleration in addition to the target distance, as the constraint condition. Concretely, when the driver selects the fuel-efficient traveling mode and inputs the target distance and the maximum acceleration as the constraint condition, the ECU 10 calculates the traveling pattern in which the maximum acceleration is generated by the time the vehicle arrives at the target distance and the total fuel consumption amount becomes minimal. Namely, under the constraint condition related to the target distance and the maximum acceleration, the ECU 10 calculates the optimum traveling pattern to the destination, based on the relationship between the vehicle speed and the acceleration in which the fuel consumption needed to travel the unit distance becomes minimal when the engine 8 operates in accordance with the fuel consumption optimum line.

This is because, since the method shown in the first embodiment only uses the target distance as the constraint condition, when the vehicle travels in the traveling pattern calculated by the method, there is a possibility that the vehicle cannot join the traffic flow due to an insufficiency of the acceleration.

Therefore, in the fifth embodiment, the ECU 10 calculates the traveling pattern in which the maximum value of the acceleration generated by the time the vehicle arrives at the target distance becomes the specified maximum acceleration. Concretely, the ECU 10 calculates the traveling pattern in which the maximum acceleration is generated by the time the vehicle arrives at the target distance and the total fuel consumption amount becomes minimal. Namely, in the traveling patterns in which the specified maximum acceleration is generated, the ECU 10 selects the traveling pattern in which the total fuel consumption amount becomes minimal.

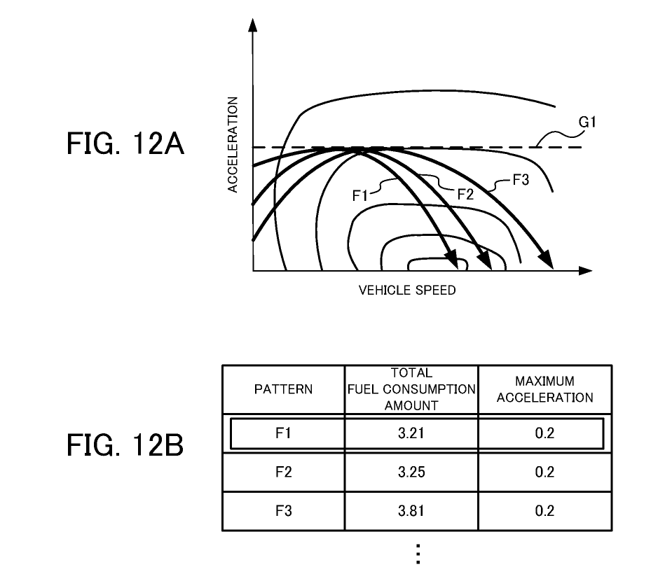

FIGS. 12A and 12B are diagrams for explaining the calculating method of the traveling pattern in the fifth embodiment. In FIG. 12A, a horizontal axis shows a vehicle speed, and a vertical axis shows an acceleration, and contour lines show the fuel consumption needed to travel the unit distance. The contour lines of the fuel consumption shown in FIG. 12A are the same as the contour lines shown in FIG. 3B.

Concretely, examples of the traveling patterns (traveling patterns F1 to F3) at the time of the calculation are shown by arrows in FIG. 12A. The traveling patterns F1 to F3 correspond to the examples of the traveling patterns calculated by the method shown in the first embodiment, by using a maximum acceleration G1 (shown by a broken line) in addition to the target distance, as the constraint condition.

FIG. 12B shows the total fuel consumption amount and the maximum acceleration which are calculated for the traveling patterns F1 to F3. Here, it is assumed that “0.2” is specified as the maximum acceleration. As for the traveling patterns F1 to F3 shown in FIG. 12B, it can be understood that the traveling pattern F1 is the pattern in which the total fuel consumption amount becomes minimal. So, the ECU 10 adopts the traveling pattern F1. Then, the ECU 10 controls the engine 8 and the continuously variable transmission 9 based on the adopted traveling pattern F1.

According to the fifth embodiment, it becomes possible to appropriately satisfy the constraint condition related to the maximum acceleration specified by the driver and minimize the total fuel consumption amount.

The fifth embodiment may be performed in combination with not less than one of the second to fourth embodiments. Concretely, in addition to the target distance and the maximum acceleration, the traveling pattern may be calculated by using not less than one of the steady traveling speed, the target arrival time and the limit value of the total fuel consumption amount, as the constraint condition.

Additionally, as another example, the traveling pattern can be calculated by using not less than two of the target distance, the steady traveling speed, the target arrival time, the limit value of the total fuel consumption amount and the maximum acceleration, as the constraint condition.

### Sixth Embodiment

Next, a description will be given of a sixth embodiment. The sixth embodiment is different from the first to fifth embodiments in that the traveling pattern is calculated by using the information obtained from the navigation system 3 as the constraint condition. Concretely, when the fuel-efficient traveling mode is selected by the driver and the constraint condition is obtained from the navigation system 3, the ECU 10 calculates the traveling pattern in which the constraint condition is satisfied and the total fuel consumption amount becomes minimal. Namely, under the constraint condition obtained from the navigation system 3, the ECU 10 calculates the optimum traveling pattern to the destination, based on the relationship between the vehicle speed and the acceleration in which the fuel consumption needed to travel the unit distance becomes minimal when the engine 8 operates in accordance with the fuel consumption optimum line.

This is because, when the constraint condition shown in the first to fifth embodiments which is specified by the driver is different from a limit of an actual traffic circumstance, it is difficult to travel in the traveling pattern calculated by the method shown in the first to fifth embodiments.

Therefore, in the sixth embodiment, the ECU 10 calculates the traveling pattern by using the information obtained from the navigation system 3 as the constraint condition. Concretely, the ECU 10 calculates the traveling pattern by using the information obtained from the navigation system 3 in addition to not less than one of the constraint conditions shown in the first to fifth embodiments. In this case, when the constraint condition is obtained from the navigation system 3, even if the constraint condition is input by the driver, the ECU 10 can prioritize the constraint condition obtained from the navigation system 3 over the constraint condition input by the driver so as to calculate the traveling pattern.

For example, when the distance to the red light is obtained from the navigation system 3, the ECU 10 uses the distance to the red light instead of the target distance specified by the driver, as the constraint condition. Additionally, when the speed limit (regulatory speed and/or legal speed) is obtained from the navigation system 3, the ECU 10 uses the speed limit instead of the steady traveling speed specified by the driver, as the constraint condition. Additionally, when the traffic flow is obtained from the navigation system 3, the ECU 10 uses the vehicle speed and the acceleration in accordance with the traffic flow instead of the steady traveling speed and the maximum acceleration specified by the driver, as the constraint condition.

Therefore, it becomes possible to perform the traveling suitable for the circumstances. The constraint condition obtained from the navigation system 3 is not limited to the above example.

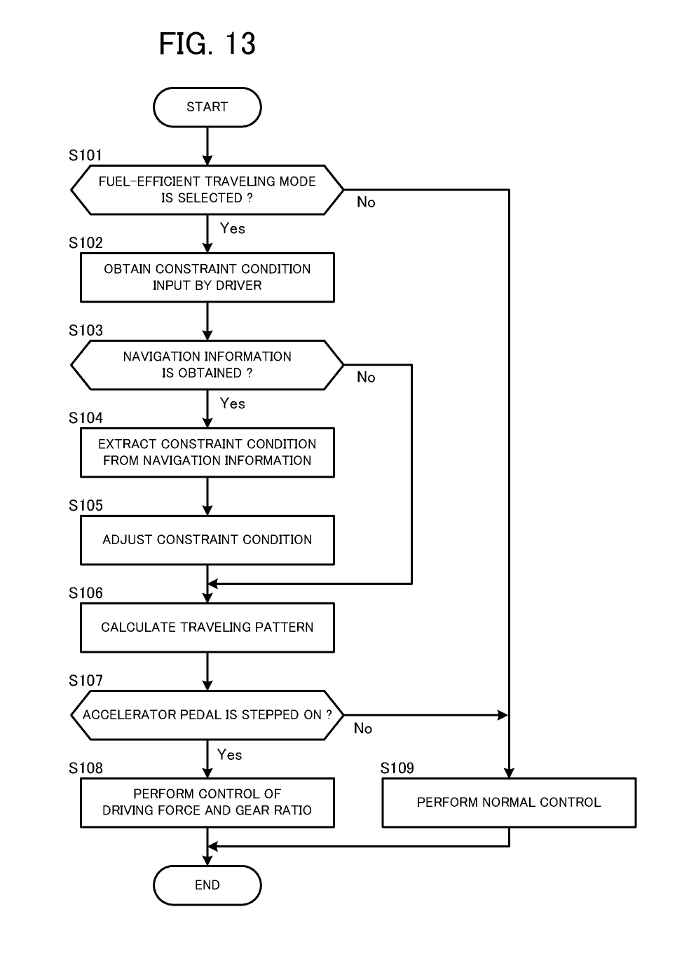

FIG. 13 is a flow chart showing a control process in the sixth embodiment. The process is repeatedly executed by the ECU 10.

First, in step S101, the ECU 10 determines whether or not the fuel-efficient traveling mode is selected by the driver. Concretely, the ECU 10 determines whether or not the fuel-efficient traveling mode switch 1 is set to the on-state.

When the fuel-efficient traveling mode is selected (step S101; Yes), the process goes to step S102. In contrast, when the fuel-efficient traveling mode is not selected (step S101; No), the process goes to step S109. In step S109, instead of performing the control based on the traveling pattern, the ECU 10 performs a normal drive control (hereinafter referred to as “normal control”). Then, the process ends.

In step S102, the ECU 10 obtains the constraint condition input by the driver. Concretely, the ECU 10 obtains not less than one of the target distance, the steady traveling speed, the target arrival time, the limit value of the total fuel consumption amount and the maximum acceleration, from the constraint condition input unit 2. Then, the process goes to step S103.

In step S103, the ECU 10 determines whether or not the information (hereinafter referred to as “navigation information”) is obtained from the navigation system 3. When the navigation information is obtained (step S103; Yes), the process goes to step S104. When the navigation information is not obtained (step S103; No), the process goes to step S106.

In step S104, the ECU 10 extracts the constraint condition from the navigation information. For example, the ECU 10 extracts the information such as the distance to the red light, the speed limit and the traffic flow, from the navigation information. Then, the process goes to step S105.

In step S105, the ECU 10 adjusts the constraint condition input by the driver, by the constraint condition extracted from the navigation information. For example, the ECU 10 sets the distance to the red light instead of the target distance, as the constraint condition, and sets the speed limit instead of the steady traveling speed, as the constraint condition, and sets the vehicle speed and the acceleration in accordance with the traffic flow instead of the steady traveling speed and the maximum acceleration, as the constraint condition. Then, the process goes to step S106.

In step S106, the ECU 10 calculates the traveling pattern by using the above constraint condition. Concretely, under the constraint condition, the ECU 10 calculates the optimum traveling pattern to the destination, based on the relationship between the vehicle speed and the acceleration in which the fuel consumption needed to travel the unit distance becomes minimal when the engine 8 operates in accordance with the fuel consumption optimum line. Then, the process goes to step S107.

In step S107, the ECU 10 determines whether or not the accelerator pedal is stepped on, based on the signal provided by the accelerator opening degree sensor 6. When the accelerator pedal is stepped on (step S107; Yes), the process goes to step S108. In step S108, since the request of the start of the traveling is issued by the driver, the ECU 10 performs the control of the driving force of the engine 8 and the control of the gear ratio of the continuously variable transmission 9, based on the traveling pattern calculated in step S106. Then, the process ends.

In contrast, when the accelerator pedal is not stepped on (step S107; No), the process goes to step S109. In this case, since the control based on the traveling pattern should not be started, the ECU 10 performs the normal control (step S109). Then, the process ends.

According to the sixth embodiment, it becomes possible to suppress the total fuel consumption amount and perform the traveling suitable for the circumstances.

### Modification

While the above embodiments show such an example that the constraint condition is obtained from the driver and the navigation system 3, the method for obtaining the constraint condition from outside is not limited to this. As another example, the constraint condition can be obtained from a center (server), a vehicle in the rear and road surface information.

Additionally, the constraint condition for calculating the traveling pattern is not limited to the above example. The condition which can limit the traveling of the vehicle may be used as the constraint condition.

Additionally, while the above embodiments show such an example that the present invention is applied to the system including the continuously variable transmission 9, the present invention can be applied to the system which does not include the continuously variable transmission 9, too.

### INDUSTRIAL APPLICABILITY

This invention can be used for various kinds of vehicles.

### DESCRIPTION OF REFERENCE NUMBERS

1 Fuel-Efficient Traveling Mode Switch

2 Constraint Condition Input Unit

3 Navigation System

4 Vehicle Speed Sensor

5 Acceleration Sensor

6 Accelerator Opening Degree Sensor

8 Engine

9 Continuously Variable Transmission

10 ECU

10a Traveling Pattern Calculating Unit

10b Control Determining Unit

10d Engine Control Unit

10f Transmission Control Unit

1. A drive control device for a vehicle, comprising:
a total fuel consumption amount calculating unit which calculates fuel consumption amount when the vehicle travels a unit distance at a predetermined vehicle speed and a predetermined acceleration which define a traveling pattern, for each of plural traveling patterns indicating a relationship between a vehicle speed and an acceleration when the vehicle travels a target distance, by using a relationship between a vehicle speed, an acceleration and fuel consumption amount needed to travel a unit distance when an engine operates in accordance with a fuel consumption optimum line, and calculates total fuel consumption amount by integrating the calculated fuel consumption amount when with respect to a time axis in accordance with the target distance; and
a traveling pattern calculating unit which calculates a traveling pattern which should be adopted in the plural traveling patterns, based on the total fuel consumption amount.

2. The drive control device for the vehicle according to claim 1,
wherein the traveling pattern calculating unit calculates the traveling pattern so that the total fuel consumption amount becomes minimal.

3. The drive control device for the vehicle according to claim 1,
wherein the traveling pattern calculating unit obtains a limit value of fuel consumption amount from outside, and calculates the traveling pattern so that the total fuel consumption amount becomes equal to or smaller than the limit value.

4. The drive control device for the vehicle according to claim 1,
wherein the traveling pattern calculating unit obtains a vehicle speed when the vehicle performs a steady traveling, from outside, and calculates the traveling pattern so that the vehicle performs the steady traveling at the vehicle speed.

5. The drive control device for the vehicle according to claim 1,
wherein the traveling pattern calculating unit obtains target arrival time to arrive at the target distance, from outside, and calculates the traveling pattern so that arrival time to arrive at the target distance becomes equal to or shorter than the target arrival time.

6. The drive control device for the vehicle according to claim 1,
wherein the traveling pattern calculating unit obtains a maximum acceleration from outside, and calculates the traveling pattern so that a maximum value of an acceleration generated by the time the vehicle arrives at the target distance becomes the maximum acceleration.

7. A drive control device for a vehicle, comprising:
a unit which calculates a traveling pattern indicating a relationship between a vehicle speed and an acceleration when the vehicle travels a target distance corresponding to a distance from a departure place to a destination so that, when the target distance is equal to or larger than a predetermined distance, a steady traveling to be performed by the time the vehicle arrives at the target distance is performed in a shorter time than when the target distance is smaller than the predetermined distance.
